(19) United States
(12) Patent Application Publication
(10) Pub. No.: US 2022/0337331 A1
(43) Pub. Date: Oct. 20, 2022

(54) UTILIZING HIGH-BANDWIDTH MEMORY AND MULTI-THREAD PROCESSORS TO IMPLEMENT A PRECISION TIME MEMORY AND SYNCHRONOUS PROCESSING SYSTEM ON A NETWORK INTERFACE CARD

(71) Applicant: Meta Platforms, Inc., Menlo Park, CA (US)

(72) Inventors: Ahmad Byagowi, Mountain View, CA (US); Hans-Juergen Schmidtke, Mountain View, CA (US)

(21) Appl. No.: 17/580,509

(22) Filed: Jan. 20, 2022

Related U.S. Application Data
(60) Provisional application No. 63/174,661, filed on Apr. 14, 2021.

(51) Int. Cl. H04J 3/06; H04L 69/16

(52) U.S. Cl. CPC H04J 3/0661; H04L 69/16

(57) ABSTRACT

The disclosed computer-implemented method may include (i) assigning, by a source computing device, a timestamp to each of one or more clock synchronization protocol transactions, (ii) storing, by the source computing device, the clock synchronization protocol transactions to a high-bandwidth memory device, and (iii) synchronizing, by the source computing device, the clock synchronization protocol transactions with a destination computing device by: issuing data transport protocol packets to preserve a timing accuracy; and sending the clock synchronization protocol transactions to a destination computing device. Various other methods, systems, and computer-readable media are also disclosed.

### CROSS REFERENCE TO RELATED APPLICATION

This application claims the benefit of U.S. Provisional Application No. 63/174,661, filed Apr. 14, 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for using a precision time memory and synchronous processing system on a network interface card (NIC).

FIG. 2 is a block diagram of an exemplary system for a precision time memory and synchronous processing system on a NIC.

FIG. 3 is a block diagram of another exemplary system for a precision time memory and synchronous processing system on a NIC.

FIG. 4 is a flow diagram of another exemplary method for using a precision time memory and synchronous processing system on a NIC.

FIG. 5 is a communication chart for using a precision time memory and synchronous processing system on a NIC.

FIG. 6 is a block diagram of another exemplary method for using a precision time memory and synchronous processing system on a NIC.

FIG. 7 is a block diagram of exemplary precision time protocol transactions that may be performed by the exemplary methods and systems of FIGS. 1-6.

FIG. 8 is a block diagram of exemplary layers in a communication model that may be utilized by the exemplary methods and systems of FIGS. 1-6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Clock synchronization protocol networks, such as Precision Time Protocol (PTP) networks, may typically consist of multiple individual nodes representing various network devices/appliances that collaborate to perform a variety of tasks involving synchronizing multiple clocks to meet various metrics associated with conducting financial transactions (e.g., banking, high-speed trading, etc.) and/or other time-sensitive activities. For examples, PTP nodes utilized in data centers for performing various PTP transactions (e.g., blind write, coherent memory, or distributed registers) often require nanosecond timing accuracy.

Conventional datacenters that host PTP networks often utilize software applications for maintaining synchronization between network nodes. However, the use of these applications often result in increased latency of PTP transactions due to userland (i.e., the various programs and libraries that a computing operating system uses to interact with the kernel). In particular, due to various buffering, caching, and/or other operations imposed by the computing operating system, the use of these applications often result in transaction times on the order of hundreds of microseconds, thereby greatly decreasing the timing accuracy required by PTP transactions.

The present disclosure is generally directed to a Network Interface Card (NIC) that may include a high-bandwidth memory storage (N-RAM) and a specialized and synchronized processor for executing multiple threads (N-Threads). As will be explained in greater detail below, in some embodiments, the specialized processor may utilize a Precision Time Protocol Hardware Clock (PHC) for timing (i.e., timestamping or clocking) operations such that all of the N-Threads may execute processes across a network at the same rate and in full synchronization with the resolution of instruction times. The N-RAM storage may utilize a variety of transactions directly from the PHC that are timestamped by the PHC. In some embodiments, the setup for the NIC introduces a new layer (i.e., layer 4.5) in the Open Systems Interconnection (OSI) model above layer 4 (i.e., the transport layer) and below layer 5 (i.e., the session layer) to perform a variety of precision time-based (i.e., PTP) transactions including, without limitation, blind write, dirty write, consensus write, distrusted write, broadcast write, coherent memory, exclusive lock share, distributed atomic clocks, distributed registers, etc. In some examples, both read and write PTP transactions may be performed.

By using the systems and methods disclosed herein, various applications may utilize the N-RAM and N-Threads for performing PTP transactions without the need to send transmission control protocol (TCP) or user datagram protocol (UDP) packets as required by conventional applications that rely on computing device operating system operations (i.e., userland) for performing these transactions with decreased timing accuracy. As a result, and due to the N-RAM and N-Threads described herein residing on the NIC and having direct access to the PHC, the nanosecond time accuracy required by various PTP transactions may be preserved.

Features from any of the embodiments described herein may be used in combination with one another in accordance with the general principles described herein. These and other embodiments, features, and advantages will be more fully understood upon reading the following detailed description in conjunction with the accompanying drawings and claims.

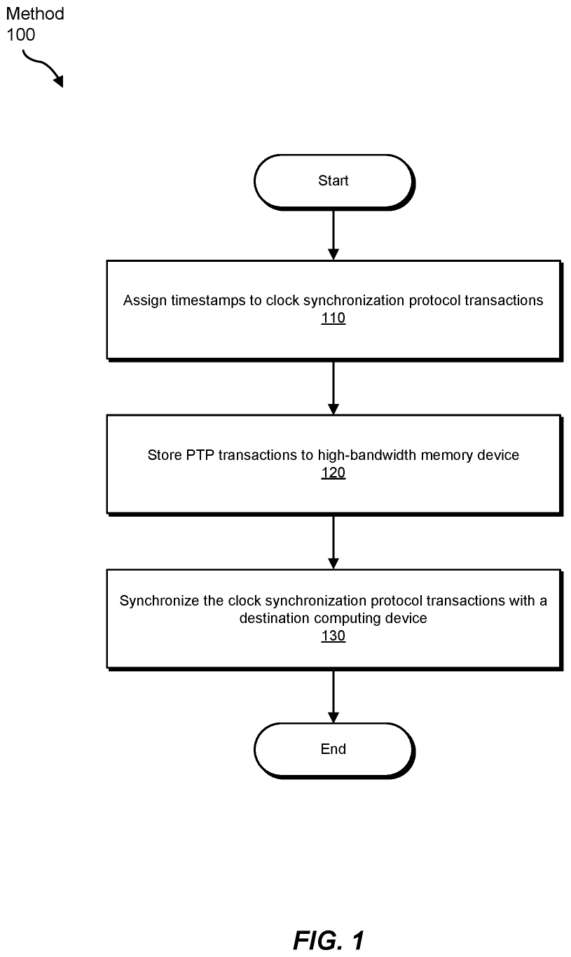

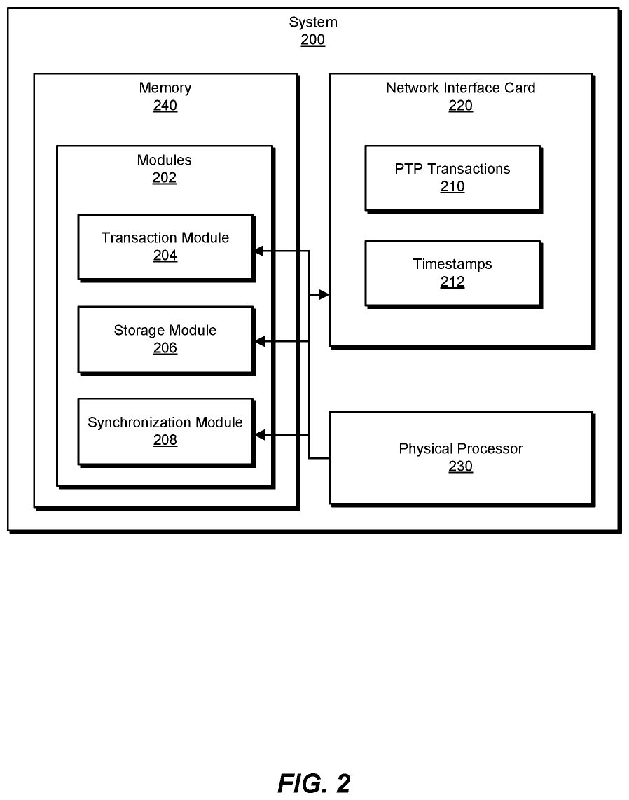

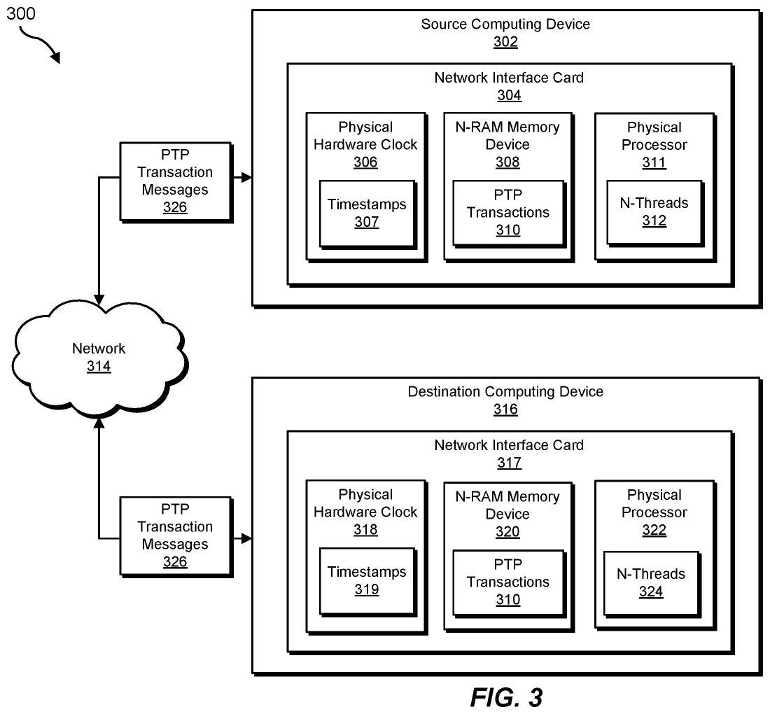

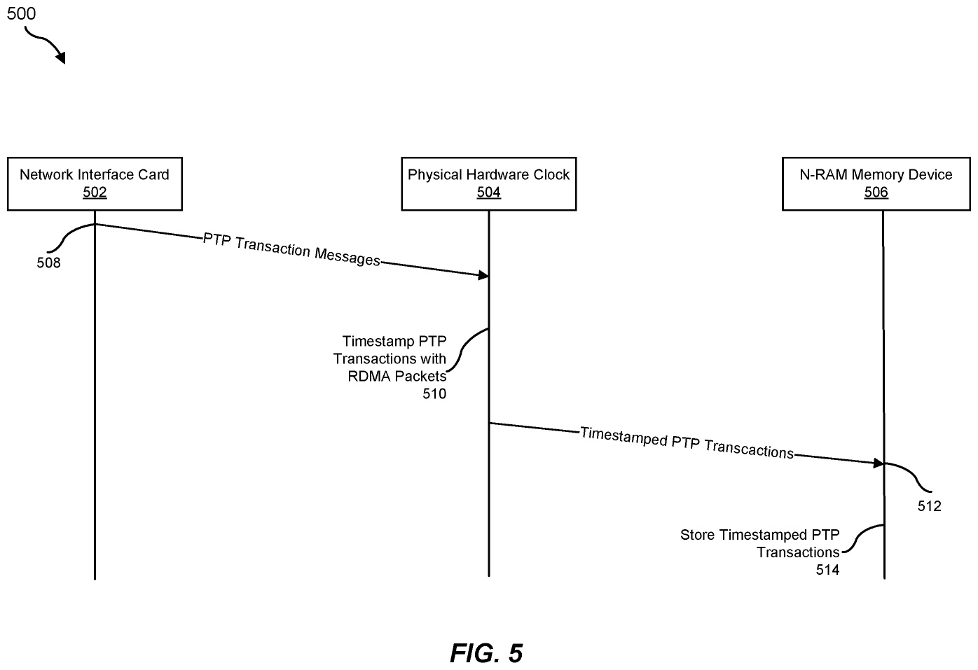

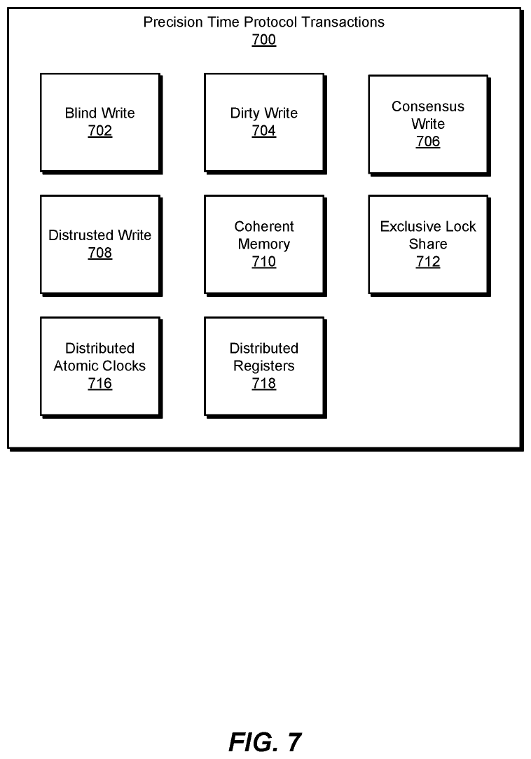

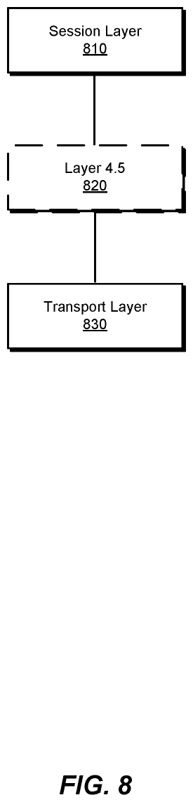

The following will provide, with reference to FIGS. 1, 4, and 6, detailed descriptions of example computer-implemented methods for using a precision time memory and synchronous processing system on a NIC. Detailed descriptions of corresponding example systems will also be provided in connection with FIGS. 2-3. Additionally, a detailed description of a corresponding example communication chart will also be provided in connection with FIG. 5. Additionally, detailed descriptions of corresponding example precision time protocol transactions that may be performed by the example methods and systems of FIGS. 1-6 will also be provided in connection with FIG. 7. Additionally, a detailed description of corresponding example layers in a communication model that may be utilized by the exemplary methods and systems of FIGS. 1-6 will also be provided in connection with FIG. 8.

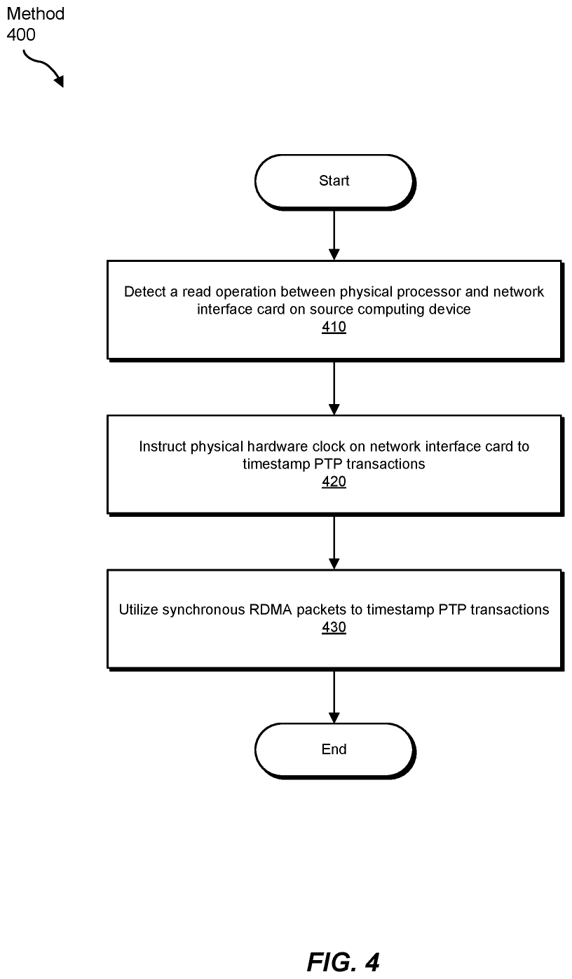

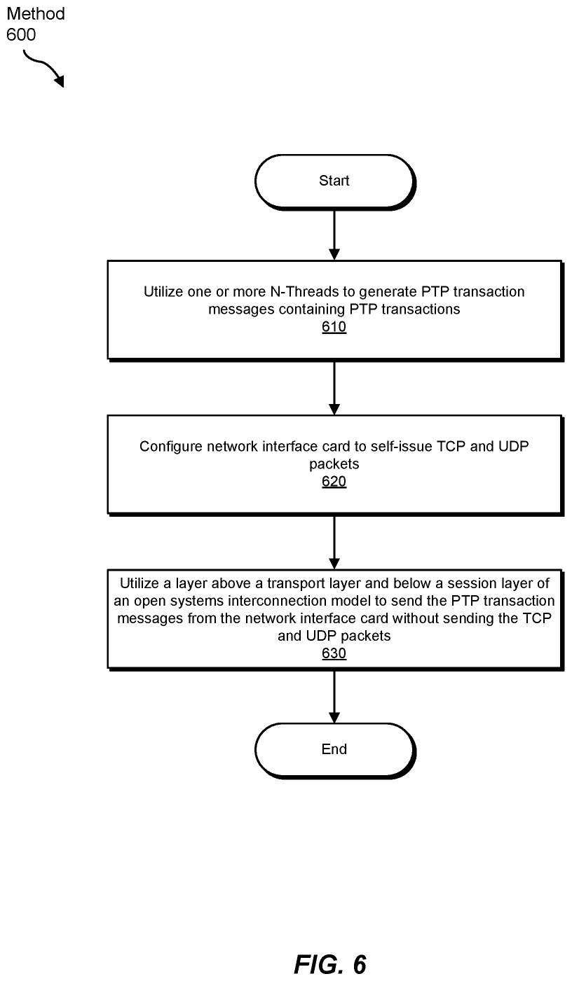

FIG. 1 is a flow diagram of an exemplary computer-implemented method 100 for using a precision time memory (i.e., N-RAM) and synchronous processing system (i.e., N-Threads) on a NIC. The steps shown in FIG. 1 (as well as the steps shown in FIGS. 4 and 6) may be performed by any suitable computer-executable code and/or computing system, including the systems illustrated in FIGS. 2 and 3. In one example, each of the steps shown in FIG. 1 may represent an algorithm whose structure includes and/or is represented by multiple sub-steps, examples of which will be provided in greater detail below.

The exemplary computer-implemented method shown in the flow diagram of FIG. 1 (as well the computer-implemented methods shown in the flow diagrams of FIGS. 4 and 6 which will also be described herein) may be performed at least in part by systems 200 and 300 of FIGS. 2 and 3, respectively. As shown in FIG. 2, system 200 may include a memory 240 and a physical processor 230. Within memory 240, modules 202 may be stored. Modules 202 may include a transaction module 204, a storage module 206, and a synchronization module 208. Modules 202 may facilitate the performance of method 100 at least in part by interacting with a network interface card (NIC) 220, which may include PTP transactions 210 and timestamps 212, as discussed in greater detail below.

As shown in FIG. 3, system 300 may include a source computing device 302 that communicates (i.e., transmits and receives) PTP transaction messages 326 (i.e., messages containing PTP transactions 310 stored on N-RAM memory devices 308 and 320) with a destination computing device 316 over a network 314. In some examples, system 300 may represent one or more datacenters for performing PTP transactions over a network. Source computing device 302 may include a network interface card (NIC) 304. NIC 304 may include a physical hardware clock (PHC) 306, an N-RAM memory device 308, and a physical processor 311 configured to run one or more N-Threads 312. Similarly, destination computing device 316 may include a NIC 317, physical hardware clock (PHC) 318, an N-RAM memory device 320, and a physical processor 322 configured to run one or more N-Threads 324. In some examples, N-RAM memory devices 308 and 320 may be high-bandwidth memory devices capable of providing remote direct memory access (RDMA). “RDMA” may generally refer to a direct memory access from the memory of one computing device into that of another without involving either computing device's operating system, thereby permitting high-throughput and low-latency networking.

Returning to FIG. 1, at step 110 one or more of the systems described herein may assign timestamps to clock synchronization protocol transactions on source network device 302. For example, transaction module 204 may assign timestamps 307 to PTP transactions 310 in system 300.

Transaction module 204 may perform step 110 in a variety of ways as will now be described with respect to the computer-implemented method 400 of FIG. 4. At step 410, one or more of the systems described herein may detect a read operation between the physical processor and network interface card on the source computing device (as shown in FIG. 3). For example, NIC 304 may be configured to detect whenever physical processor 311 reads instructions (e.g., timestamp instructions) from NIC 304. Additionally or alternatively, physical processor 311 may be configured to detect whenever NIC 304 reads instructions (e.g., timestamp instructions) from physical processor 311.

At step 420, one or more of the systems described herein may instruct physical hardware clock on network interface card to timestamp the PTP transactions. For example, physical processor 311 on source network device 302 may instruct PHC 306 to timestamp PTP transactions 310.

At step 430, one or more of the systems described herein may utilize synchronous RDMA packets to timestamp the PTP transactions. For example, PHC 306 may utilize synchronous RDMA packets to timestamp PTP transactions 310 on source network device 302. In some examples, PHC 306 may timestamp PTP transactions 310 prior to PTP transactions 310 being communicated in PTP transaction messages 326 to destination computing device 316. In these examples, destination computing device 316 may look at (i.e., read) timestamps 307 assigned to PTP transactions 310 for synchronization with source network device 302. Additionally or alternatively, PHC 306 may utilize transactional RDMA packets during a high-level logic section in which a portion of N-RAM memory device 308 may be assigned to an atomic operation (i.e., an operation that may always be executed without any other process being able to read or change state that is read or changed during the operation).

Returning now to FIG. 1, at step 120, one or more of the systems described herein may store PTP transactions assigned timestamps at step 120. For example, storage module 206 may store PTP transactions 310 that have been assigned timestamps 307 by PHC 306.

Storage module 206 may perform step 120 in a variety of ways. In some examples, one or more N-Threads 312 executing on physical processor 311 may instruct N-RAM memory device 308 to store PTP transactions 310 after they have been timestamped by PHC 306. In some examples, N-RAM memory device 308 may store a variety of PTP transactions such as PTP transactions 700 shown in FIG. 7. For example, PTP transactions 700 may include, without limitation, blind write 702, dirty write 704, consensus write 706, distrusted write 708, coherent memory 710, exclusive lock share 712, distributed atomic clocks 716, and distributed registers 718.

FIG. 5 is a communication chart 500 for using a precision time memory and synchronous processing system on a NIC. Communication chart 500 shows a network interface card 502 (i.e., NIC 502), a physical hardware clock 504 (i.e., PHC 504), and an N-RAM memory device 506. At 508, NIC 502 may send PTP transaction messages to PHC 504. Next, PHC 504 may, at 510, timestamp PTP transactions contained in the PTP transaction messages utilizing RDMA packets (e.g., synchronous RDMA packets for PTP transactions associated with non-atomic operations and transactional RDMA packets for PTP transactions associated with atomic operations).

At 512, PHC 504 may then send the timestamped transactions to N-RAM memory device 506. Next, at 514, N-RAM memory device 506 may store the timestamped PTP transactions.

Returning now to FIG. 1, at step 130, one or more of the systems described herein may synchronize the clock synchronization protocol transactions with a destination computing device. For example, synchronization module 208 may PTP transactions 310, that have been assigned timestamps 307 by PHC 306, with network interface card 317 on destination computing device 316. In some embodiments, synchronization module 208 may be configured to self-issue data transport protocol packets (e.g., TCP/UDP packets) via NIC 304 to preserve a timing accuracy (e.g., a nanosecond timing accuracy) and to send PTP transactions 310 to destination computing device (i.e., without sending the TCP/UDP packets).

Synchronization module 208 may perform step 130 in a variety of ways as will now be described with respect to the computer-implemented method 600 of FIG. 6. At step 610, one or more of the systems described herein may utilize one or more N-Threads to generate PTP transaction messages containing PTP transactions. For example, synchronization module 208 may utilize N-Threads 312 of physical processor 311 on NIC 304 to generate PTP transaction messages 326 containing PTP transactions 310 previously assigned timestamps 307 by PHC 306, for sending from source computing device 302 to destination computing device 316.

At step 620, one or more of the systems described herein may configure NIC to self-issue TCP and UDP packets. For example, synchronization module 208 may configure NIC 304 to self-issue TCP/UDP packets typically sent utilizing the OSI layer 4 transport layer.

At step 630, one or more of the systems described herein may utilize a layer above a transport layer and below a session layer of an open systems interconnection (OSI) model to send the PTP transaction messages from the NIC without sending the TCP and UDP packets. For example, synchronization module 208 may utilize OSI layer 4.5 (which is shown in FIG. 8 as layer 4.5 800 between transport layer 830 (i.e., layer 4) and session layer 810 (i.e., layer 5)). In this example, OSI layer 4.5 may represent a new layer added to the standard OSI model to enable NIC 304 to issue itself the TCP/UDP packets typically sent utilizing the OSI layer 4 transport layer.

Conventional applications rely on computing device operating system operations (i.e., userland) for performing PTP transactions resulting in decreased timing accuracy. The present disclosure describes a Network Interface Card (NIC) that may include a memory storage (N-RAM) and a specialized and synchronized processor for executing multiple threads (N-Threads). In some embodiments, the specialized processor may utilize a Precision Time Protocol Hardware Clock (PHC) for timing (i.e., clocking) operations such that all of the N-Threads may execute processes across a network at the same rate and in full synchronization with the resolution of instruction times. The N-RAM storage may utilize a variety of transactions directly from the PHC that are timestamped by the PHC. In some embodiments, the setup for the NIC introduces a new layer (i.e., layer 4.5) in the Open Systems Interconnection (OSI) model above layer 4 (i.e., the transport layer) and below layer 5 (i.e., the session layer) to perform a variety of precision time-based (i.e., PTP) transactions including, without limitation, blind write, dirty write, consensus write, distrusted write, broadcast write, coherent memory, exclusive lock share, distributed atomic clocks, distributed registers, etc. In some examples, both read and write PTP transactions may be performed. By utilizing the N-RAM and N-Threads for performing PTP transactions, there is no need to send TCP or UDP packets due to the N-RAM and N-Threads and residing on the NIC and having direct access to the PHC. As a result, the nanosecond time accuracy required by various PTP transactions may be preserved.

### EXAMPLE EMBODIMENTS

Example 1: A computer-implemented method may include assigning, by a source computing device, a timestamp to each of one or more clock synchronization protocol transactions; storing, by the source computing device, the clock synchronization protocol transactions to a high-bandwidth memory device; and synchronizing, by the source computing device, the clock synchronization protocol transactions with a destination computing device without sending transmission control protocol (TCP) and user datagram protocol (UDP) packets to preserve nanosecond timing accuracy associated with the clock synchronization protocol transactions.

Example 2: The computer-implemented method of Example 1, wherein assigning the timestamp to each of the one or more clock synchronization protocol transactions comprises assigning the timestamp to one or more precision time protocol (PTP) transactions.

Example 3: The computer-implemented method of any of Examples 1 and 2, wherein assigning the timestamp to each of the one or more PTP transactions comprises: detecting a read operation between a physical processor and a network interface card on the source computing device; and instructing a physical hardware clock on the network interface card to timestamp the PTP transactions upon detecting the read operation.

Example 4: The computer-implemented method of any of Examples 1-3, wherein assigning the timestamp to each of the one or more PTP transactions comprises utilizing synchronous remote direct memory access (RDMA) packets to timestamp the PTP transactions.

Example 5: The computer-implemented method of any of Examples 1-4, wherein assigning the timestamp to each of the one or more PTP transactions comprises utilizing transactional RDMA packets to timestamp the PTP transactions.

Example 6: The computer-implemented method of any of Examples 1-5, wherein the transactional RDMA packets are utilized during a high-level logic session.

Example 7: The computer-implemented method of any of Examples 1-6, wherein the high-level logic session comprises a communication session wherein at least a portion of the high-bandwidth memory device is assigned to an atomic operation.

Example 8: The computer-implemented method of any of Examples 1-7, wherein storing the clock synchronization protocol transactions to the high-bandwidth memory device comprises instructing an N-RAM memory device to store timestamped PTP transactions.

Example 9: The computer-implemented method of any of Examples 1-8, wherein synchronizing the clock synchronization protocol transactions with the destination computing device comprises: utilizing one or more N-Threads on the source computing device to generate PTP transaction messages containing PTP transactions; and sending the PTP transaction messages to the destination computing device.

Example 10: The computer-implemented method of any of Examples 1-9, wherein sending the PTP transaction messages to the destination computing device comprises: configuring a network interface card on the source computing device to self-issue the data transport protocol packets, wherein the data transport protocol packets comprise transmission control protocol (TCP) and user datagram protocol (UDP) packets; and utilizing a layer above a transport layer and below a session layer of an open systems interconnection model to send the PTP transaction messages from the network interface card without sending the TCP and UDP packets to preserve the timing accuracy, wherein the timing accuracy comprises a nanosecond timing accuracy associated with the PTP transactions.

Example 11: A system comprising: at least one physical processor; and physical memory comprising computer-executable instructions that, when executed by the physical processor, cause the physical processor to: assign, by a transaction module, a timestamp to each of one or more clock synchronization protocol transactions; store, by a storage module, the clock synchronization protocol transactions to a high-bandwidth memory device; and synchronize, by a synchronization module, the clock synchronization protocol transactions with a destination computing device by: issuing data transport protocol packets to preserve a timing accuracy; and sending the clock synchronization protocol transactions to a destination computing device.

Example 12: The system of Example 11, wherein the transaction module assigns the timestamp to each of the one or more clock synchronization protocol transactions by assigning the timestamp to one or more precision time protocol (PTP) transactions.

Example 13: The system of any of Examples 11-12, wherein the transaction module assigns the timestamp to each of the one or more PTP transactions by: detecting a read operation between a physical processor and a network interface card on a source computing device; and instructing a physical hardware clock on the network interface card to timestamp the PTP transactions upon detecting the read operation.

Example 14: The system of any of Examples 11-13, wherein the transaction module assigns the timestamp to each of the one or more PTP transactions by utilizing synchronous remote direct memory access (RDMA) packets to timestamp the PTP transactions.

Example 15: The system of any of Examples 11-14, wherein the transaction module assigns the timestamp to each of the one or more PTP transactions by utilizing transactional RDMA packets to timestamp the PTP transactions.

Example 16: The system of any of Examples 11-15, wherein the transactional RDMA packets are utilized during a high-level logic session; and at least a portion of the high-bandwidth memory device is assigned to an atomic operation.

Example 17: The system of any of Examples 11-16, wherein the storage module stores the clock synchronization protocol transactions to the high-bandwidth memory device by instructing an N-RAM memory device to store timestamped PTP transactions.

Example 18: The system of any of Examples 11-17, wherein the synchronization module synchronizes the clock synchronization protocol transactions with the destination computing device by: utilizing one or more N-Threads on a source computing device to generate PTP transaction messages containing PTP transactions; and sending the PTP transaction messages to the destination computing device.

Example 19: The system of any of Examples 11-18, wherein the synchronization module sends the PTP transaction messages to the destination computing device by: configuring a network interface card on the source computing device to self-issue the data transport protocol packets, wherein the data transport protocol packets comprise transmission control protocol (TCP) and user datagram protocol (UDP) packets; and utilizing a layer above a transport layer and below a session layer of an open systems interconnection model to send the PTP transaction messages from the network interface card without sending the TCP and UDP packets to preserve the timing accuracy, wherein the timing accuracy comprises a nanosecond timing accuracy associated with the PTP transactions.

Example 20: A non-transitory computer-readable medium comprising one or more computer-executable instructions that, when executed by at least one processor of a computing device, cause the computing device to: assign a timestamp to each of one or more clock synchronization protocol transactions; store the clock synchronization protocol transactions to a high-bandwidth memory device; and synchronize the clock synchronization protocol transactions with a destination computing device without sending transmission control protocol (TCP) and user datagram protocol (UDP) packets to preserve nanosecond timing accuracy associated with the clock synchronization protocol transactions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
assigning, by a source computing device, a timestamp to each of one or more clock synchronization protocol transactions;
storing, by the source computing device, the clock synchronization protocol transactions to a high-bandwidth memory device; and
synchronizing, by the source computing device, the clock synchronization protocol transactions with a destination computing device by:
issuing data transport protocol packets to preserve a timing accuracy; and
sending the clock synchronization protocol transactions to a destination computing device.

2. The computer-implemented method of claim 1, wherein assigning the timestamp to each of the one or more clock synchronization protocol transactions comprises assigning the timestamp to one or more precision time protocol (PTP) transactions.

3. The computer-implemented method of claim 2, wherein assigning the timestamp to each of the one or more PTP transactions comprises:
detecting a read operation between a physical processor and a network interface card on the source computing device; and
instructing a physical hardware clock on the network interface card to timestamp the PTP transactions upon detecting the read operation.

4. The computer-implemented method of claim 2, wherein assigning the timestamp to each of the one or more PTP transactions comprises utilizing synchronous remote direct memory access (RDMA) packets to timestamp the PTP transactions.

5. The computer-implemented method of claim 2, wherein assigning the timestamp to each of the one or more PTP transactions comprises utilizing transactional RDMA packets to timestamp the PTP transactions.

6. The computer-implemented method of claim 5, wherein the transactional RDMA packets are utilized during a high-level logic session.

7. The computer-implemented method of claim 6, wherein the high-level logic session comprises a communication session wherein at least a portion of the high-bandwidth memory device is assigned to an atomic operation.

8. The computer-implemented method of claim 1, wherein storing the clock synchronization protocol transactions to the high-bandwidth memory device comprises instructing an N-RAM memory device to store timestamped PTP transactions.

9. The computer-implemented method of claim 1, wherein synchronizing the clock synchronization protocol transactions with the destination computing device comprises:
utilizing one or more N-Threads on the source computing device to generate PTP transaction messages containing PTP transactions; and
sending the PTP transaction messages to the destination computing device.

10. The computer-implemented method of claim 9, wherein sending the PTP transaction messages to the destination computing device comprises:
configuring a network interface card on the source computing device to self-issue the data transport protocol packets, wherein the data transport protocol packets comprise transmission control protocol (TCP) and user datagram protocol (UDP) packets; and
utilizing a layer above a transport layer and below a session layer of an open systems interconnection model to send the PTP transaction messages from the network interface card without sending the TCP and UDP packets to preserve the timing accuracy, wherein the timing accuracy comprises a nanosecond timing accuracy associated with the PTP transactions.

11. A system comprising:
at least one physical processor;
physical memory comprising computer-executable instructions that, when executed by the physical processor, cause the physical processor to:
assign, by a transaction module, a timestamp to each of one or more clock synchronization protocol transactions;
store, by a storage module, the clock synchronization protocol transactions to a high-bandwidth memory device; and
synchronize, by a synchronization module, the clock synchronization protocol transactions with a destination computing device by:
issuing data transport protocol packets to preserve a timing accuracy; and
sending the clock synchronization protocol transactions to a destination computing device.

12. The system of claim 11, wherein the transaction module assigns the timestamp to each of the one or more clock synchronization protocol transactions by assigning the timestamp to one or more precision time protocol (PTP) transactions.

13. The system of claim 12, wherein the transaction module assigns the timestamp to each of the one or more PTP transactions by:
detecting a read operation between a physical processor and a network interface card on a source computing device; and
instructing a physical hardware clock on the network interface card to timestamp the PTP transactions upon detecting the read operation.

14. The system of claim 12, wherein the transaction module assigns the timestamp to each of the one or more PTP transactions by utilizing synchronous remote direct memory access (RDMA) packets to timestamp the PTP transactions.

15. The system of claim 12, wherein the transaction module assigns the timestamp to each of the one or more PTP transactions by utilizing transactional RDMA packets to timestamp the PTP transactions.

16. The system of claim 15, wherein:
the transactional RDMA packets are utilized during a high-level logic session; and
at least a portion of the high-bandwidth memory device is assigned to an atomic operation.

17. The system of claim 11, wherein the storage module stores the clock synchronization protocol transactions to the high-bandwidth memory device by instructing an N-RAM memory device to store timestamped PTP transactions.

18. The system of claim 11, wherein the synchronization module synchronizes the clock synchronization protocol transactions with the destination computing device by:
utilizing one or more N-Threads on a source computing device to generate PTP transaction messages containing PTP transactions; and
sending the PTP transaction messages to the destination computing device.

19. The system of claim 18, wherein the synchronization module sends the PTP transaction messages to the destination computing device by:
configuring a network interface card on the source computing device to self-issue the data transport protocol packets, wherein the data transport protocol packets comprise transmission control protocol (TCP) and user datagram protocol (UDP) packets; and
utilizing a layer above a transport layer and below a session layer of an open systems interconnection model to send the PTP transaction messages from the network interface card without sending the TCP and UDP packets to preserve the timing accuracy, wherein the timing accuracy comprises a nanosecond timing accuracy associated with the PTP transactions.

20. A non-transitory computer-readable medium comprising one or more computer-executable instructions that, when executed by at least one processor of a computing device, cause the computing device to:
assign a timestamp to each of one or more clock synchronization protocol transactions;
store the clock synchronization protocol transactions to a high-bandwidth memory device; and
synchronize the clock synchronization protocol transactions with a destination computing device by:
issuing data transport protocol packets to preserve a timing accuracy; and
sending the clock synchronization protocol transactions to a destination computing device.
